(19) United States
(12) Patent Application Publication
(10) Pub. No.: US 2006/0174089 A1
(43) Pub. Date: Aug. 3, 2006

(54) Method and apparatus for embedding wide instruction words in a fixed-length instruction set architecture

(75) Inventors: Erik Richter Altman, Danbury, CT (US); Michael Karl Gschwind, Chappaqua, NY (US); Daniel Arthur Prener, Briarcliff Manor, NY (US); Jude A. Rivers, Cortlandt Manor, NY (US); Sumedh W. Sathaye, Cary, NC (US); John-David Wellman, Hopewell Junction, NY (US); Victor V. Zyuban, Yorktown Heights, NY (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/047,983

(22) Filed: Feb. 1, 2005

(51) Int. Cl. G06F 15/00

(52) U.S. Cl. 712/24

(57) ABSTRACT

A method, system, and computer program product for mixing of conventional and augmented instructions within an instruction stream, wherein control may be directly transferred, without operating system intervention, between one type of instruction to another. Extra instruction word bits are added in a manner that is designed to minimally interfere with the encoding, decoding, and instruction processing environment in a manner compatible with existing conventional fixed instruction width code. A plurality of instruction words are inserted into an instruction word oriented architecture to form an encoding group of instruction words. The instruction words in the encoding group are dispatched and executed either independently or in parallel based on a specific microprocessor implementation. The encoding group does not indicate any form of required parallelism or sequentiality. One or more indicators for the encoding group are created, wherein one indicator is used to indicate presence of the encoding group.

### BACKGROUND OF THE INVENTION

1. Technical Field

This invention relates generally to digital data processor architectures and, more specifically, relates to program instruction decoding and execution hardware.

2. Description of Related Art

A number of data processor instruction set architectures (ISAs) operate with fixed length instructions. For example, several Reduced Instruction Set Computer (RISC) architecture data processors feature instruction words that have a fixed width of 32 bits. One such example is the PowerPC™, which is a product available from International Business Machines Corporation (IBM). Another conventional architecture, known as IA-64 EPIC (Explicitly Parallel Instruction Computer), uses a fixed format of three operations per 128 bits. In other architectures such as the IBM System/360 and zSeries architectures, the Intel 8086 architecture, the Advanced Microdevices'AMD64 architecture, or the Digital Equipment VAX architecture, each instruction is of variable length, the length being specified by length field which is part of the instruction word.

As instruction pipelines become deeper and memory latencies become longer, more instructions must be executing simultaneously so as to keep data processor execution units well utilized. However, in order to increase the number of non-memory operations in flight, it is generally necessary to increase the number of registers in the data processor, so that independent instructions may read their inputs and write their outputs without interfering with the execution of other instructions. Unfortunately, in most RISC architectures there is not sufficient space in a 32-bit instruction word for operands to specify more than 32 registers, i.e., 5-bits per operand, with most operations requiring three operands and some requiring two or four operands. Other architectures, such as the MIPS architecture (a product of MIPS Technologies, Inc.) and the ARM architecture (a product of ARM Ltd.), offer a mode that allows for selecting between two different instruction encoding formats. For example, in one mode, all instructions are of a first width (e.g., 32 bits for the MIPS32 and ARM architectures, respectively), and in another mode, all instructions are of a second width (e.g., 16 bits for the MIPS 16 and Thumb architectures, respectively). Thumb architecture is an extension to the 32-bit ARM architecture. The Thumb instruction set features a subset of the most commonly used 32-bit ARM instructions which have been compressed into 16-bit wide opcodes.

In addition, as conventional fixed-width data processor architectures age, new applications become important, and these new applications may require new types of instructions to run efficiently. For example, in the last few years, multimedia vector extensions have been made to several ISAs, such as the MMX, SSE, SSE2, and SSE3 extensions for the Intel 8086 architecture and Altivec/VMX for the PowerPC™ architecture. However, with only a fixed number of bits in an instruction word, it has become increasingly difficult or impossible to add new instructions and specifically operation code encodings (opcodes) and wide register specifiers to many architectures.

Several techniques for extending instruction word length have been proposed and used in the prior art. For example, Complex Instruction Set Computer (CISC) architectures generally allow the use of a variable length instruction. However, traditional variable instruction lengths, e.g., as those employed by the Intel 8086 architecture, have at least three significant drawbacks. A first drawback to the use of variable length instructions is that they complicate the decoding of instructions, as the instruction length is generally not known until at least a part of the instruction has been read, and because the positions of all operands within an instruction are likewise not generally known until at least part of the instruction is read. A second drawback to the use of variable length instructions is that instructions of variable width are not compatible with the existing code for fixed width data processor architectures. A third drawback is that conventional variable length instructions require complex decoders which can start at arbitrary instruction addresses, complicating and slowing down instruction decode logic.

Although the use of a fixed width 64-bit instruction word (or other higher powers of two) may allow for avoiding the first and third problems mentioned above, the use of a fixed width 64-bit instruction word still does not overcome the second problem. In addition, the use of 64-bit instructions introduces the further difficulty that the additional 32-bits beyond the current 32-bit instruction words are far more than what is needed to specify the numbers of additional registers required by deeper instruction pipelines, or the number of additional opcodes likely to be needed in the foreseeable future. The use of excess instruction bits wastes space in main memory and in instruction caches, thereby slowing the performance of the data processor.

An approach of encoding instructions in a first fixed width (e.g., 2 bytes) and a second double fixed width (e.g., 4 bytes) has been previously used in the IBM RT PC ROMP processor and is disclosed by P. Hester et al. “The IBM RT PC ROMP and Memory Management Unit Architecture”, IBM RT Personal Computer Technology, 1986. To prevent crossing of page boundaries for doublewide instructions, the encoded instructions can further be required to start at a doublewide instruction address boundary (e.g., an instruction byte address being an integral multiple of 4) or an address not within 3 bytes before a boundary not to be crossed.

For example, the XL2067 and XL8220, products of Weitek Corporation, use a method to subdivide a 4 byte space to support into a 1 byte and a 3 byte instruction. This is a means to embed multiple short instructions efficiently in an instruction stream.

In addition, U.S. Pat. No. 5,625,784, entitled “Variable Length Instructions Packed in a Fixed Length Double Instruction”, also discloses a method to subdivide the number of bits used by two instructions to provide up to 4 variable length instructions. Optionally, two short “flexible” instructions can be present. This method is undesirable as variable length instructions are inherently slow and hard to decode. In one aspect of the cited invention, an extended variable length instruction can be generated by concatenating one of a first and second base instruction with additional instruction bytes distributed over two adjacent instruction words. The teachings of this patent require base instructions to be aligned at instruction word boundaries, leading to restrictions in possible instructions to be used. The encoding is undesirable for hardware implementations because it requires performing alignment of instruction bits. Such signal crossing is costly in modern designs. Finally, while this encoding allows for the insertion of one long instruction in a double instruction space, it requires the second instruction to be shorter. Thus, this invention is directed at packing multiple variable length instructions and not at supporting the pervasive use of wide instructions.

Having described instruction word oriented architectures such as RISC and CISC architectures, we now describe bundle-oriented architectures wherein an instruction consists of several operations.

The above-mentioned IA-64 EPIC architecture packs three operations into 16 bytes (128-bits), for an average of 42.67 bits per operation. While this type of instruction encoding avoids problems with page and cache line crossing, this type of instruction encoding also exhibits several problems, both on its own, and as a technique for extending other fixed instruction width ISAs. First, without incurring significant implementation difficulty (likely slowing the execution speed and requiring significantly more integrated circuit die area), this instruction encoding technique permits branches to go only to instructions starting with an operation encoded as the first of the three operations in a 128 b instruction word, whereas most other architectures allow branches to any instruction. Second, this technique also “wastes” bits for specifying the interaction between instructions. For example, instruction stops are used to indicate if all three operations can be executed in parallel, or whether they must be executed sequentially, or whether some combination of the two is possible. This approach is known as “variable length very long instruction word (VLIW)” or “variable width VLIW”. In one particular encoding used by the IA-64 architecture, the stop information and issue logic data is encoded in an instruction header, as described by Intel in “IA-64 Application Developer's Architecture Guide”. In another form of VLIW instruction encoding used by IBM's Binary-translation Optimized Architecture (BOA) processor, the stop bits are explicit, as described by Gschwind et al., “Dynamic and Transparent Binary Translation”, IEEE Computer, March 2000. Third, the three operation packing technique also forces additional complexity in the implementation in order to deal with three instructions at once. Finally, the three operation packing format for IA-64 has no requirement to be compatible with existing 32-bit instruction sets. As a result, there is no obvious mechanism to achieve compatibility with other fixed width instruction encodings, such as the conventional 32-bit RISC encodings.

Several VLIW instruction sets instruction words use an instruction format specifier to specify the internal format of operations. Examples of these architectures include the DAISY architecture described by Ebcioglu et al. in “Dynamic Binary Translation and Optimization”, IEEE Transactions on Computers, 2002, the IA-64 architecture described by Intel, and the IBM elite DSP architecture described in Moreno et al. in “An Innovative Low-Power High-Performance Programmable Signal Processor for Digital Communications,” IBM Journal of Research and Development, vol. 47, No. 2/3, pp. 299-326, 2003.

Another operation encoding technique for variable width VLIW architectures is disclosed by Moreno in U.S. Pat. No. 5,669,001 entitled, “Object Code Compatible Representation of Very Long Instruction Word Programs”, and U.S. Pat. No. 5,951,674 entitled, “Object Code Compatible Representation of Very Long Instruction Word Programs”. This encoding technique is similarly are not applicable to maintaining object code compatibility with fixed width RISC ISA architectures, but between several generations of VLIW architectures, being specifically directed towards the encoding of operations in a long instruction word.

In addition, a copending application entitled, “Method and Apparatus to Extend the Number of Instruction Bits in Processors with Fixed Length Instructions, in a Manner Compatible with Existing Code”, Ser. No. ______, attorney docket no. YOR920030405US1, filed on Nov. 24, 2003, assigned to the same assignee as the present application, describes a mechanism that allows for extending all instructions by a fixed amount. The mechanism operates by allocating an extension area, wherefrom each instruction derives several extension bits. The mechanism allows for maintaining the traditional 32-bit instruction boundaries of the PowerPC™ architecture, and for broadly maintaining compatibility with the pre-existing environment. However, because the presence of the extensions in accordance with the mechanism is indicated by a bit in the page table, all instructions on a page must be extended when even a single instruction uses the extension. This has at least two drawbacks. The first drawback stems from the fact that all instructions must be extended, even when only a few instructions on a page require the extension, leading to possibly significant inefficiency of such a page. The second drawback limits the free interlinking of binary object modules compiled with and without this extension, and specifically requires the link editor to either separate functions compiled employing the extensions from those not employing those extensions, or to patch the precompiled object modules not using the extensions to employ the extensions.

Another way to embed longer instructions is the use of indirection, that is, by storing a long instruction in a separate memory, or memory region, and referring to such instruction word by an indexing means embedded in the instruction stream. An example of an architecture employing indirection is the Billions of Operations Per Second (BOPS) architecture. BOPS has ‘indirect’ VLIW instructions that can also access all the processing elements inside the core via a 32-bit instruction path. These “indirect” instructions allow longer instruction words to be accessed by specifying which long instruction to access with a short indirect pointer fitting in a narrower instruction word, e.g., as those present in the PowerPC™ architecture. However, this architecture is optimized for such applications as digital signal processing (DSP), and thus is limited to DSP and similar applications.

Specifically, indirect methods in instruction words suffer from the following drawbacks. For instance, link editing must merge indirect tables and adjust indirect points during the final linkage step. When the indirect table overflows, no straightforward resolution is possible which allows for preserving high performance. In addition, in a multiprocessing system, different applications may require separate indirect tables, requiring to load and unload indirect tables on each context switch, thereby significantly degrading achievable performance by increasing context switch time. Not all code points can be accessed using an indirect pointer, or the pointer would have to be the same size as the expanded code space, thereby defeating the compression advantage given by the indirect approach.

For example, U.S. Patent Application No. 20030023960A1 entitled, “Microprocessor Instruction Format Using Combination Opcodes and Destination Prefixes”, describes an indirect method wherein a combination opcode is used to obtain two opcodes for two instructions from a table using the combination opcode to perform a table access.

Another existing mechanism that uses an instruction format specifier to specify the internal format of operations is found in Jani et al., “Long Words and Wide Ports: Reinventing the Configurable Processor”, Proc. of Hot Chips 16, August 2004; this method being publicly described after the invention date of the present invention, which describes a method of inserting a VLIW in a scalar instruction stream. A 32-bit or 64-bit VLIW instruction consisting of a format specifier and several operations can be embedded in a CISC instruction set containing 16-bit and 24-bit scalar instructions, based on the Flexible Length Instruction Xtensions (FLIX) extension technology, a product of Tensilica, Inc. However, while each FLIX instruction can be independently encoded and scheduled, the VLIW format requires that slots be properly coordinated, and globally shared functions between several execution operation types not be encoded in a single FLIX instruction. As all operations are executed in parallel, this would create a resource conflict, and hence it is illegal to bundle multiple operations that use the same globally shared functions. Thus, because the FLIX instruction words encoded operations which must be executed in parallel, and not instructions which can be scheduled and executed independently from each other, this makes the encoding unsuitable for dynamically scheduled machines that require the instruction scheduler to resolve execution resource dependences, and serialize resource and data dependent instructions. The Tensilica instruction set does not use fixed width instructions, yielding an instruction stream consisting of 16-bit, 24-bit, 32-bit, and 64-bit variable length instructions with arbitrary 8-bit alignment for any instruction address, resulting in the same instruction alignment issues as traditional variable length (CISC) instruction sets. This limitation makes this approach unsuitable for inclusion in a fixed length RISC ISA.

Therefore, in view of the above, it would be advantageous to have a mechanism for allowing the use of wide instructions words in an instruction set in conjunction with instruction sets that use fixed width instructions.

### SUMMARY OF THE INVENTION

The present invention provides a method, apparatus, and computer instructions for including wide instruction words in an instruction set in conjunction with instruction sets that use fixed width instructions. The extra instruction word bits are added in a manner that is designed to minimally interfere with the encoding, decoding, and instruction processing environment in a manner compatible with existing conventional fixed instruction width code. The mechanism of the present invention permits the mixing of conventional and augmented instructions within an instruction encoding group, wherein control may be directly transferred, without operating system intervention, between one type of instruction to another.

The present invention provides many advantages over existing encoding methods. With the present invention, the number of bits that are added to an instruction set as an extension is not excessive compared to what is required to specify a reasonable number of additional registers and/or opcodes. The extension may be performed only locally to a small set of instructions, where at least one instruction uses the feature, as opposed to requiring an entire page of code to be encoded in a wider encoding. The mechanism of the present invention also allows for encoding instruction addresses with the current instruction addressing infrastructure (specifically, a 32-bit or 64-bit value), and does not require additional words to store instruction addresses for purposes of indicating exceptions, function call return addresses, and register-indirect branch targets. This functionality may be combined with a preferred branch target alignment for relative and absolute addressed branches of at least the instruction encoding group size.

In addition, the mechanism of the present invention provides an encoding format where an extended instruction of the present invention may be wider in basic instruction width than the basic instruction unit size. A feature of this invention is a group-centered decoding approach for instruction encoding groups, wherein groups of instructions are decoded. A still further feature of this extension is that an instruction encoding group is an integral multiple of the original instruction size. A still further feature is that an extended instruction can be wider than the basic instruction unit size, but is not required to be an integral multiple of the basic instruction size, to avoid excessive instruction footprint growth. For example, in one embodiment, the instruction encoding group includes an extended width instruction paired with another extended width instruction of the same size, wherein the extended width instructions correspond to three fixed width instructions. In this example, the instruction encoding group is an integral multiple of the original fixed width instruction size.

Another feature of the present invention is widened instructions may be placed within the instruction stream to integrate with the fixed width instructions without permanently changing the alignment of all following instructions (e.g., even after a 48-bit instruction, a 32-bit instruction stream will remain aligned at 32-bit). For example, in one embodiment, the instruction encoding group includes an extended width instruction paired with a fixed width instruction. The fixed width instructions are padded with bit groups in order to align the fixed width instructions within the extended instruction encoding group. In this manner, extended width instructions are allowed to integrate with fixed width instructions without the alignment problems associated with variable width instruction words. In one embodiment, the bit groups used for padding are unused. In another embodiment, they extend the meaning of the included base instruction, e.g., including but not limited to providing additional bits for one or more instruction fields.

Another feature of the present invention is an instruction encoding group may encode shared information across several instructions or a modifier can be applied to several instructions. The shared field may be used to encode an instruction or indicate the selection of a specific rounding mode for all floating point instructions encoded in such a group. For example, a shared field may be an address space identifier to be used by all memory access instructions encoded in the group. In another embodiment of the present invention, at least one of predicates and predicate condition can be specified in a shared field.

In addition, the present invention provides a group-centered decoding approach, wherein groups of instructions (“instruction encoding groups”, or “encoding group”) are decoded. While previous ISAs have supported bundles, they have not supported the concept of instruction encoding groups. Thus, instruction extensions such as the FLIX instructions require supporting the start of instructions at arbitrary byte addresses. Furthermore, FLIX bundles are VLIW instructions which encode multiple operations to be executed in parallel, restricting the freedom of the instruction scheduler, as well as of microarchitects in choosing what resources to share in a specific implementation of a processor. In contrast, the instruction encoding groups of the present invention do not imply the presence or absence of parallelism, as used by previous bundle uses. Instead, instruction encoding groups allow the efficient encoding of fixed width and extended width instructions in a fixed width ISA coding system without specifying a required parallel or non-parallel execution, the presence of stop bits, or other information restricting the instruction scheduler of a RISC processor.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a data processing system in which the present invention may be implemented;

FIG. 2 is an exemplary block diagram of a processor system for processing information in accordance with a preferred embodiment of the present invention;

FIG. 3 is an exemplary diagram of a known encoding scheme of a CISC instruction set based on the Intel 8086 ISA;

FIG. 4 is a flow diagram of a known process for decoding of the CISC instruction set in FIG. 3;

FIG. 5 is an exemplary diagram of known fixed-width instruction formats of the MIPS R3000 architecture;

FIG. 6 is a flow diagram of a known process for decoding the 32-bit RISC microprocessor instruction set in FIG. 5;

FIG. 7 is an exemplary diagram of a known encoding of a template-based fixed width instruction bundle format used by the IA64 architecture;

FIG. 8 is a flow diagram of a known process for decoding of VLIW instruction bundles containing several operations with fixed operation width;

FIG. 9 is an exemplary diagram of a known advanced VLIW architecture supporting 64 instruction words having between 1 to 3 operations of variable length;

FIG. 10 is a flow diagram of a known process for decoding the advanced bundle format in FIG. 9;

FIG. 11A is an exemplary diagram of a known encoding of an ARM instruction set;

FIG. 11B is an exemplary diagram of a known encoding of a Thumb instruction set;

FIG. 12 is a flow diagram of a known process for decoding instructions in a dual-format ISA microprocessor;

FIG. 13A is an exemplary diagram of a known 32-bit PowerPC™ instruction;

FIG. 13B is an exemplary diagram illustrating a 48-bit PowerPC™ instruction paired with another 48-bit instruction to yield a 96-bit instruction encoding group in accordance with a preferred embodiment of the present invention;

FIG. 13C is an exemplary diagram illustrating an encoding group consisting of two paired 48 bit instructions, the encoding group being indicated by the opcode of a first 48-bit instruction, said instruction having a 12-bit primary opcode consisting of a first 6-bit opcode portion and a second 6-bit opcode portion in accordance with a preferred embodiment of the present invention;

FIG. 13D is an exemplary diagram illustrating an encoding group consisting of two paired 48-bit instructions, the encoding group being indicated by the 6-bit opcode of a first 48-bit instruction, with 48-bit extensions also having a 12-bit secondary opcode in accordance with a preferred embodiment of the present invention;

FIG. 13E is an exemplary diagram illustrating a 48-bit PowerPC™ instruction paired with a 32-bit instruction and a 16-bit unused field in accordance with a preferred embodiment of the present invention;

FIG. 13F is an exemplary diagram illustrating a 48-bit PowerPC™ instruction paired with a 32-bit instruction having a special header to identify using a 32-bit instruction in a 48-bit encoding slot in accordance with a preferred embodiment of the present invention;

FIG. 14 is a flow diagram of a RISC processor supporting the presence of 32-bit instructions, or paired 48-bit instructions, in accordance with a preferred embodiment of the present invention;

FIG. 15A is an exemplary diagram illustrating an instruction encoding group for instructions in accordance with a preferred embodiment of the present invention;

FIG. 15B is an exemplary diagram illustrating an instruction encoding group having shared fields in accordance with a preferred embodiment the present invention;

FIG. 15C is an exemplary diagram illustrating an instruction encoding group having a shared predicate field and a one-bit true/false indicator in accordance with a preferred embodiment of the present invention; and

FIG. 16 is a flow diagram of a process for decoding instructions in a RISC processor having 32-bit fixed width instructions in FIG. 13A and an encoding group of three instructions having a total of 128-bits in FIG. 15A or 15B in accordance with a preferred embodiment of the present invention.

### DETAILED DESCRIPTION OF THE PREFERRED EMBODIMENT

It is noted at the outset that this invention will be described below in the context of an extension of 32-bit instruction words, of a type commonly employed in RISC architectures, to include extended instruction words. However, instruction width augmentation for other fixed width instruction sizes (e.g., 64-bits, or 128-bits) are also within the scope of this invention. Similarly, the extension configurations used for exemplary exposition are an encoding group of 2 instructions of 48 b width, or a group consisting of an encoding group of 128 b width containing three instructions. Again, other widths of encoding groups are in the scope of the present invention, and can be practiced using any instruction width and group width. Examples are also made using a variety of instruction sets, and particularly the IBM PowerPC™ instruction set architecture. Again, extensions of other ISAs are within the scope of the present invention. Thus, those skilled in the art should realize that the ensuing description, and specific references to numbers of bits, instruction widths, and code systems are not intended to be read in a limiting sense upon the practice of this invention.

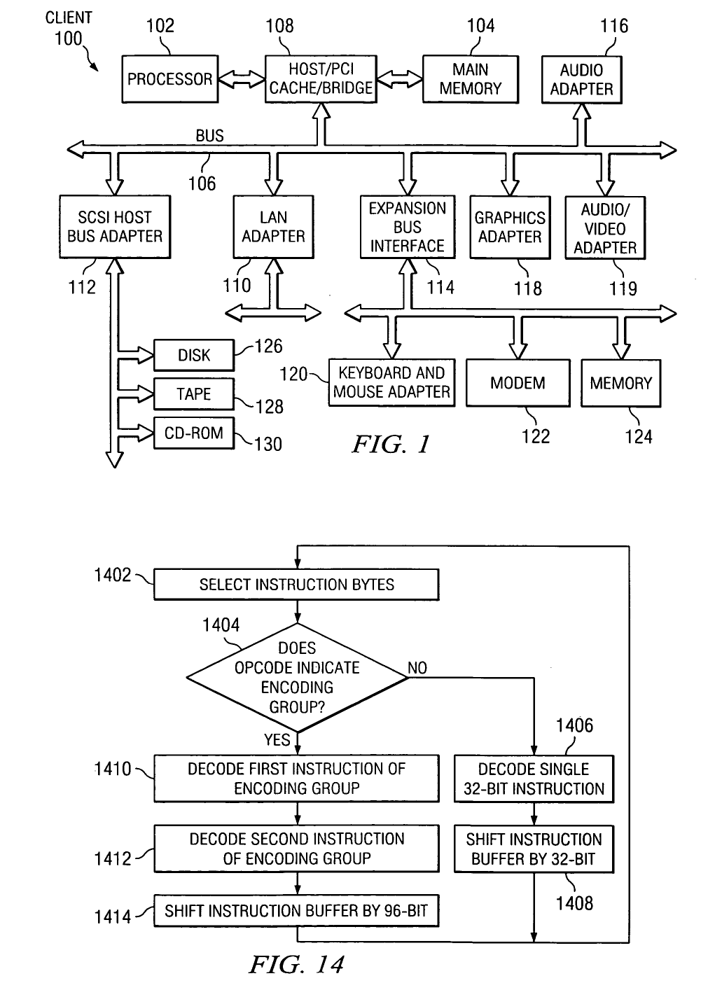

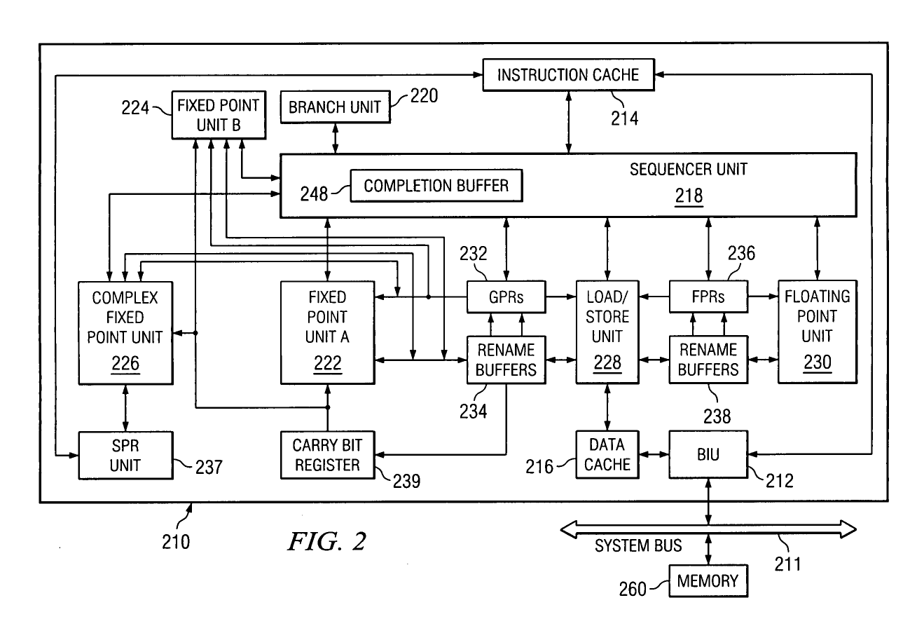

The present invention may be implemented in a computer system. Therefore, the following FIGS. 1 and 2 are provided in order to give an environmental context in which the operations of the present invention may be implemented. FIGS. 1 and 2 are only exemplary and no limitation on the computing environment or computing devices in which the present invention may be implemented is intended or implied by the depictions in FIGS. 1 and 2.

With reference now to FIG. 1, an exemplary block diagram of a data processing system is shown in which the present invention may be implemented. System 100 is an example of a computer, in which code or instructions implementing the processes of the present invention may be located. Exemplary system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 connect to PCI local bus 106 through PCI bridge 108. PCI bridge 108 also may include an integrated memory controller and cache memory for processor 102. Additional connections to PCI local bus 106 may be made through direct component interconnection or through add-in boards.

In the depicted example, local area network (LAN) adapter 110, small computer system interface SCSI host bus adapter 112, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. SCSI host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and coordinates and provides control of various components within data processing system 100 in FIG. 1. The operating system may be a commercially available operating system such as AIX, which is available from International Business Machines Corporation, or the freely available Linux operating system.

Those of ordinary skill in the art will appreciate that the hardware in FIG. 1 may vary depending on the implementation. Other internal hardware or peripheral devices, such as flash read-only memory (ROM), equivalent nonvolatile memory, or optical disk drives and the like, may be used in addition to or in place of the hardware depicted in FIG. 1. Also, the processes of the present invention may be applied to a multiprocessor data processing system.

The processes of the present invention are performed by processor 102 using computer implemented instructions, which may be located in a memory such as, for example, main memory 104, memory 124, or in one or more peripheral devices 126-130.

Turning next to FIG. 2, an exemplary block diagram of a processor system for processing information is depicted in accordance with a preferred embodiment of the present invention. Processor 210 may be implemented as processor 102 in FIG. 1.

In a preferred embodiment, processor 210 is a single integrated circuit superscalar microprocessor, preferably implementing the PowerPC architecture. Accordingly, as discussed further herein below, processor 210 includes various units, registers, buffers, memories, and other sections, all of which are formed by integrated circuitry. As shown in FIG. 2, system bus 211 connects to a bus interface unit (“BIU”) 212 of processor 210. BIU 212 controls the transfer of information between processor 210 and system bus 211.

BIU 212 connects to an instruction cache 214 for storing instruction words in accordance with the present invention and to data cache 216 of processor 210. Instruction cache 214 outputs instructions encoded in accordance with the to sequencer unit 218. In response to such instructions from instruction cache 214, sequencer unit 218 selectively outputs instructions to other execution circuitry of processor 210.

In addition to sequencer unit 218, in the preferred embodiment, the execution circuitry of processor 210 includes multiple execution units, namely a branch unit 220, a fixed-point unit A (“FXUA”) 222, a fixed-point unit B (“FXUB”) 224, a complex fixed-point unit (“CFXU”) 226, a load/store unit (“LSU”) 228, and a floating-point unit (“FPU”) 230. FXUA 222, FXUB 224, CFXU 226, and LSU 228 input their source operand information from general-purpose architectural registers (“GPRs”) 232 and fixed-point rename buffers 234. In prior art, these are addressed by a number of bits encoded in the instruction word of a fixed width RISC ISA. In accordance with the present invention, wide instruction words can be embedded in the instruction stream to optionally address more architected GPRs. Moreover, FXUA 222 and FXUB 224 input a “carry bit” from a carry bit (“CA”) register 239. FXUA 222, FXUB 224, CFXU 226, and LSU 228 output results (destination operand information) of their operations for storage at selected entries in fixed-point rename buffers 234. Also, CFXU 226 inputs and outputs source operand information and destination operand information to and from special-purpose register processing unit (“SPR unit”) 237.

FPU 230 inputs its source operand information from floating-point architectural registers (“FPRs”) 236 and floating-point rename buffers 238. FPU 230 outputs results (destination operand information) of its operation for storage at selected entries in floating-point rename buffers 238. In prior art, these are addressed by a number of bits encoded in the instruction word of a fixed width RISC ISA. In accordance with the present invention, wide instruction words can be embedded in the instruction stream to optionally address more architected FPRs.

In response to a Load instruction, LSU 228 inputs information from data cache 216 and copies such information to selected ones of rename buffers 234 and 238. If such information is not stored in data cache 216, then data cache 216 inputs (through BIU 212 and system bus 211) such information from a system memory 239 connected to system bus 211. Moreover, data cache 216 is able to output (through BIU 212 and system bus 211) information from data cache 216 to system memory 239 connected to system bus 211. In response to a Store instruction, LSU 228 inputs information from a selected one of GPRs 232 and FPRs 236 and copies such information to data cache 216.

Sequencer unit 218 inputs and outputs information to and from GPRs 232 and FPRs 236 by decoding instruction words. In accordance with the present invention, instruction words can either have a fixed width instruction length, or contain embedded wide instruction words. From sequencer unit 218, branch unit 220 inputs instructions and signals indicating a present state of processor 210. In response to such instructions and signals, branch unit 220 outputs (to sequencer unit 218) signals indicating suitable memory addresses storing a sequence of instructions for execution by processor 210. In response to such signals from branch unit 220, sequencer unit 218 inputs the indicated sequence of instructions from instruction cache 214. If one or more of the sequence of instructions is not stored in instruction cache 214, then instruction cache 214 inputs (through BIU 212 and system bus 211) such instructions from system memory 239 connected to system bus 211.

In response to the instructions input from instruction cache 214, sequencer unit 218 selectively dispatches the instructions to selected ones of execution units 220, 222, 224, 226, 228, and 230. Each execution unit executes one or more instructions of a particular class of instructions. For example, FXUA 222 and FXUB 224 execute a first class of fixed-point mathematical operations on source operands, such as addition, subtraction, ANDing, ORing and XORing. CFXU 226 executes a second class of fixed-point operations on source operands, such as fixed-point multiplication and division. FPU 230 executes floating-point operations on source operands, such as floating-point multiplication and division.

As information is stored at a selected one of rename buffers 234, such information is associated with a storage location (e.g., one of GPRs 232 or carry bit (CA) register 242) as specified by the instruction for which the selected rename buffer is allocated. Information stored at a selected one of rename buffers 234 is copied to its associated one of GPRs 232 (or CA register 242) in response to signals from sequencer unit 218. Sequencer unit 218 directs such copying of information stored at a selected one of rename buffers 234 in response to “completing” the instruction that generated the information. Such copying is called “writeback.”

As information is stored at a selected one of rename buffers 238, such information is associated with one of FPRs 236. Information stored at a selected one of rename buffers 238 is copied to its associated one of FPRs 236 in response to signals from sequencer unit 218. Sequencer unit 218 directs such copying of information stored at a selected one of rename buffers 238 in response to “completing” the instruction that generated the information.

Processor 210 achieves high performance by processing multiple instructions simultaneously at various ones of execution units 220, 222, 224, 226, 228, and 230. Accordingly, each instruction is processed as a sequence of stages, each being executable in parallel with stages of other instructions. Such a technique is called “pipelining.”

In the fetch stage, sequencer unit 218 selectively inputs (from instruction cache 214) one or more instructions from one or more memory addresses storing the sequence of instructions discussed further hereinabove in connection with branch unit 220, and sequencer unit 218. In the decode stage, sequencer unit 218 decodes up to four fetched instructions.

In the dispatch stage, sequencer unit 218 selectively dispatches up to four decoded instructions to selected (in response to the decoding in the decode stage) ones of execution units 220, 222, 224, 226, 228, and 230 after reserving rename buffer entries for the dispatched instructions' results (destination operand information). In the dispatch stage, operand information is supplied to the selected execution units for dispatched instructions. Processor 210 dispatches instructions in order of their programmed sequence.

In the execute stage, execution units execute their dispatched instructions and output results (destination operand information) of their operations for storage at selected entries in rename buffers 234 and rename buffers 238 as discussed further hereinabove. In this manner, processor 210 is able to execute instructions out-of-order relative to their programmed sequence.

In the completion stage, sequencer unit 218 indicates an instruction is “complete.” Processor 210 “completes” instructions in order of their programmed sequence.

In the writeback stage, sequencer 218 directs the copying of information from rename buffers 234 and 238 to GPRs 232 and FPRs 236, respectively. Sequencer unit 218 directs such copying of information stored at a selected rename buffer. Likewise, in the writeback stage of a particular instruction, processor 210 updates its architectural states in response to the particular instruction. Processor 210 processes the respective “writeback” stages of instructions in order of their programmed sequence. Processor 210 advantageously merges an instruction's completion stage and writeback stage in specified situations.

In the illustrative embodiment, each instruction requires one machine cycle to complete each of the stages of instruction processing. Nevertheless, some instructions (e.g., complex fixed-point instructions executed by CFXU 226) may require more than one cycle. Accordingly, a variable delay may occur between a particular instruction's execution and completion stages in response to the variation in time required for completion of preceding instructions.

Completion buffer 248 is provided within sequencer 218 to track the completion of the multiple instructions that are being executed within the execution units. Upon an indication that an instruction or a group of instructions have been completed successfully, in an application specified sequential order, completion buffer 248 may be utilized to initiate the transfer of the results of those completed instructions to the associated general-purpose registers.

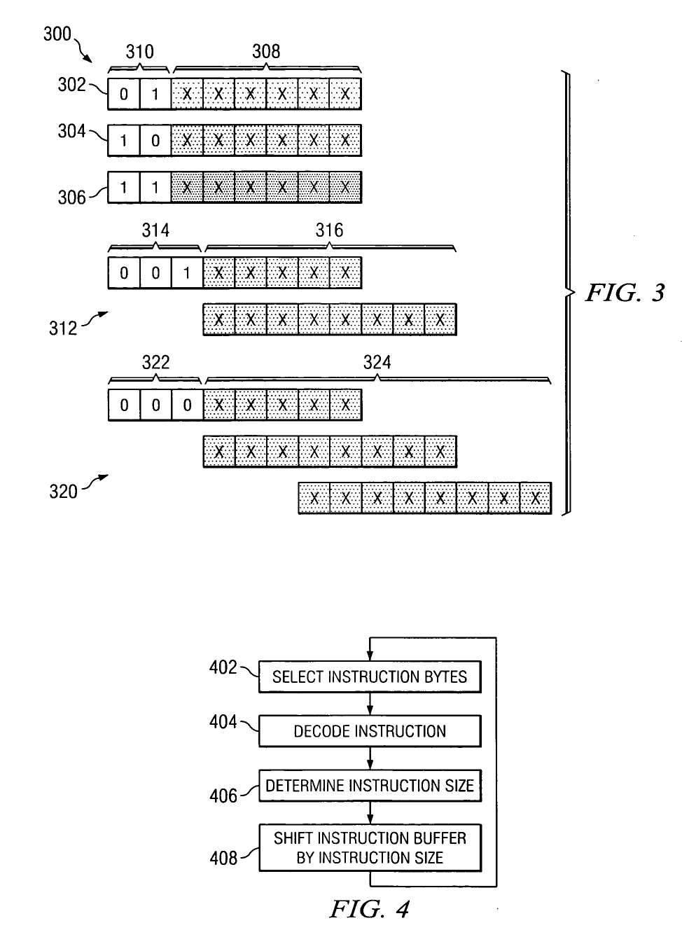

FIG. 3 is an exemplary diagram of a known encoding scheme of a CISC instruction set based on the Intel 8086 ISA. In this encoding scheme, the first 2 or 3 bits, respectively, identify instructions as having 1, 2, or 3 bytes. In variable length instruction based ISAs, all instructions follow this encoding scheme. For instance, with regard to instruction set 300, three one-byte instructions 302, 304, and 306 are shown. The first two bits in instructions 302, 304, and 306 comprise opcodes 310 which are used to identify the instruction width. As the opcodes for instructions 302, 304, and 306 are not “00”, each instruction 302, 304, and 306 is indicated to be one-byte long. The remaining bits in each instruction, such as bits 3 through 8 308 in instruction 302, are used to encode the one-byte instructions.

An encoding scheme for a two-byte instruction 312 is also shown. The first three bits in instruction 312 comprise the opcode for identifying the instruction width. As opcode 314 in instruction 312 is “001”, instruction 312 is two-bytes long. The remaining bits in instruction 312, such as bits 4 through 16 316, are used to encode the two-byte instruction.

An encoding scheme for a three-byte instruction 320 is provided. In a similar manner to two-byte instruction 312, the first three bits in instruction 320 comprise the opcode for identifying the instruction width. However, as the first three bits in opcode 322 are “000”, instruction 320 is indicated to be three bytes long. The remaining bits in instruction 320 such as bits 4 through 24 324, are used to encode the three-byte instruction.

However, conventional variable length instructions, such as those instruction described above, are not compatible with the existing code for fixed width data processor architectures. Conventional variable length instructions also require complex decoders that can start at arbitrary instruction addresses; complicating and slowing down instruction decode logic. For example, FIG. 4 illustrates how the use of conventional variable length encoding schemes can complicate the decoding of instructions.

In particular, FIG. 4 is a flow diagram of a known process for decoding of the CISC instruction set in FIG. 3. In this exemplary process, a CISC processor first selects instruction bytes for decoding (step 402). The CISC processor decodes the selected instruction bytes (step 404). As the CISC processor decodes the instruction bytes, the instruction size is determined from the information in the opcode, such as opcode 302 in FIG. 3. Once the instruction has been decoded, the CISC processor shifts the instruction buffer by the instruction size (step 408), thereby eliminating the decoded instruction and allowing the processor to view the next instruction in the set. Thus, with the variable length encoding scheme, the length of the instruction and the positions of all operands in the instruction are generally not known until at least a part of the instruction has been read. The need to identify the instruction length based on the instruction opcode leads to inefficient parallel decoding. In modern implementations, this is only partially addressed by moving partial decoding to the instruction cache hierarchy and storing additional information (e.g., an internal code form, or instruction boundary and size information in the instruction cache hierarchy).

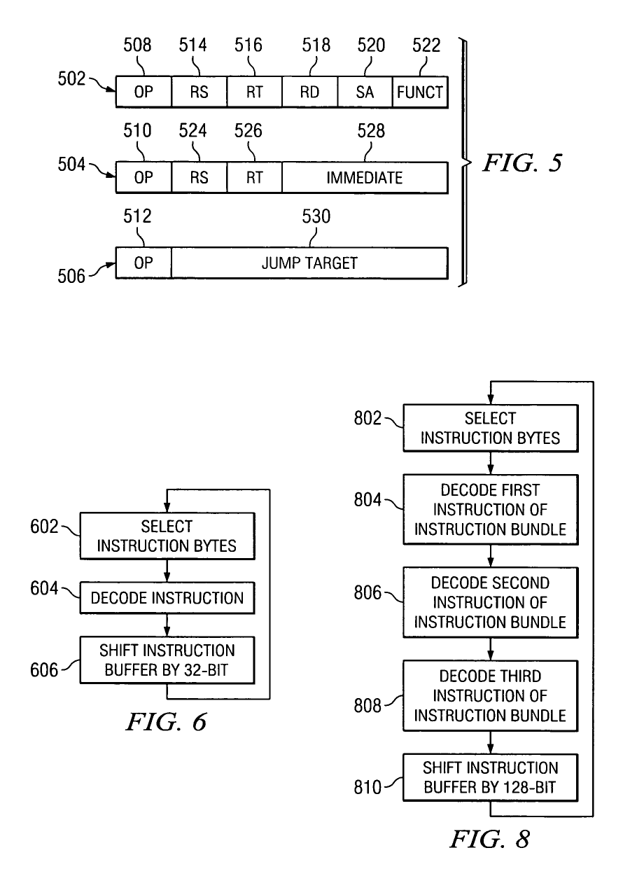

Turning now to FIG. 5, an exemplary diagram of a known encoding scheme of a RISC instruction set based on the MIPS R3000 architecture is shown. The instruction set and processor architecture are based on the MIPS-X research prototype developed at Stanford University. The MIPS-X processor is described in Chow and Horowitz, “Architectural Tradeoffs in the Design of MIPS-X” and Horowitz et al., “MIPS-X: A 20-MIPS Peak, 32-bit Microprocessor with On-Chip Cache”, JSSC, Vol. SC-22, No 5, Oct 1987. In fixed width instruction based ISAs, all instructions follow this encoding scheme.

For example, FIG. 5 illustrates three instruction formats, 502, 504, and 506. Each instruction 502, 504, and 506 format is 32 bits in length, and includes an opcode field, such as opcode fields 508, 510, and 512. Each opcode specifies the nature of the particular instruction. In particular, instruction 502 represents a format typically used for three-register instructions. Main processor instructions that do not require a target address, immediate value, or branch displacement use this coding format. This format has fields for specifying up to three registers and a shift amount. The three-register instructions each read two source registers and write to one destination register. For instance, in addition to opcode field 508 which contains a first part of the opcode, instruction 502 includes a first source register (RS) operand 514, a second source register (RT) operand 516, a destination register (RD) operand 518, a shift amount (SA) 520, and a function (Funct) 522, which is the second part of the opcode. For instructions that do not use all of these fields, the unused fields are coded with all 0 bits.

With regard to instructions 504 and 506, instruction 504 represents a format typically used for instructions requiring immediates. An immediate is a constant value stored in the instruction itself. In addition to opcode field 510 and first and second source register operands 524 and 526, instruction 504 includes immediate field 528 that codes an immediate operand, a branch target offset, or a displacement for a memory operand. Instruction 506 represents a format typically used for jump instructions. These instructions require a memory address to specify the target of the jump 530.

Although the use of fixed width instructions by RISC processors may overcome some of the issues in using variable length instructions, fixed width instructions still contain many disadvantages. As more instructions must be executing at the same time so as to keep data processor execution units well utilized, it is generally necessary to increase the number of registers in the data processor, so that independent instructions may read their inputs and write their outputs without interfering with the execution of other instructions. Yet in most RISC architectures, there is not sufficient space in a 32-bit instruction word for operands to specify more than 32 registers. In addition, with only a fixed number of bits in an instruction word, it has become increasingly difficult or impossible to add new instructions and specifically opcode encodings and wide register specifiers to many architectures.

FIG. 6 is an exemplary decoding process for a fixed length encoding scheme. In particular, FIG. 6 is a flow diagram of a known process for decoding the 32-bit RISC microprocessor instruction set in FIG. 5. In this exemplary process, a RISC processor first selects instruction bytes for decoding (step 602). The RISC processor decodes the selected instruction bytes (step 604). Once the instruction has been decoded, the RISC processor shifts the instruction buffer by the instruction size (step 606), thereby eliminating the decoded instruction and allowing the processor to view the next instruction in the set.

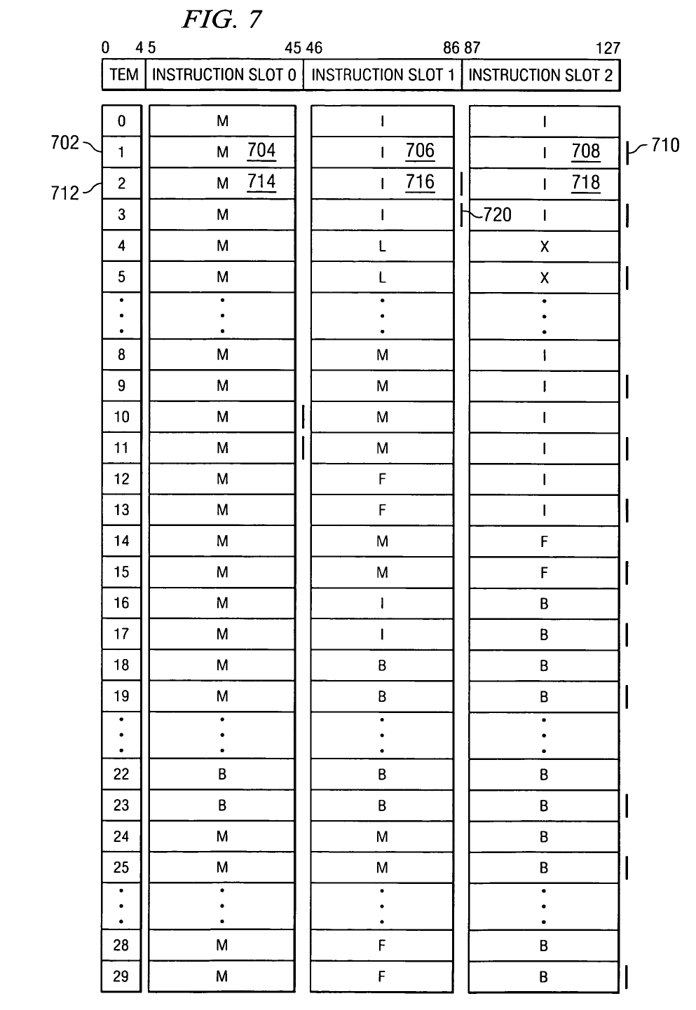

Turning next to FIG. 7, an exemplary diagram of a known template-based fixed width operation bundle format used by the IA-64 architecture is shown. IA-64 has 128 integer and 128 floating-point registers, four times as many registers as a typical RISC architecture, allowing the compiler to expose and express an increased amount of ILP (instruction-level parallelism). The IA-64 instruction format bundles three operations into a bundle, and each instruction is placed within a 41-bit instruction slot. The format also includes a five-bit template specifier for each 128-bit bundle, the template being used to identify whether all three operations can be executed in parallel, or whether they must be executed sequentially, or whether some combination of the two is possible. For instance, instructions that have no dependencies amongst them may execute in parallel. The template also specifies inter-instruction information, shown by the dark bars in FIG. 7. These template-specified stop bits indicate that those instructions after the stop bits are to be executed in the next instruction bundle.

For example, U.S. Pat. No. 5,922,065 entitled, “Processor Utilizing a Template Field for Encoding Instruction Sequences in a Wide-Word Format”, discloses the format used in the IA-64 architecture. It should be noted that this patent uses a different naming scheme, referring to operations as used in this application as “instructions”, and to instructions as used in this application as “instruction group”. That an instruction group is in fact a group of operations to be executed concurrently is specified in the description and claims of the U.S. Pat. No. 5,922,065, such as claim 17 which specifies that an instruction group is “comprising a set of statically contiguous instructions that are executed concurrently”. The specific bundle architecture described in this patent further limits certain instruction slots to specific execution units based on a limited amount of template codes as shown in FIG. 7, which is an additional undesirable limitation.

Finally, in operation bundle based ISAs, all instructions follow this encoding scheme and thus cannot be properly integrated into a pre-existing fixed width RISC ISA.

For example, instruction bundle 702 comprises a memory operation (M) 704 and two integer (I) operations, 706 and 708. Stop bit 710 is positioned after integer operations 708, terminating a single instruction consisting at least of operations 704, 706 and 708; thus, instruction bundle 712 is executed in the next clock cycle for a program having a sequence of operation bundles corresponding to those shown in FIG. 7. While bundle 712 also comprises a memory operation 714 and two integer operations 716 and 718, only memory operation 712 and integer operation 716 are executed in the same clock cycle, since stop bit 720 indicates that integer operation 718 is to be executed in the following clock cycle as part of a new instruction.

However, this type of instruction encoding also exhibits several problems, both on its own, and as a technique for extending other fixed instruction width ISAs. First, this coding technique is used for encoding operations which are part of a long instruction word which is to be scheduled in parallel, not as part of independent instructions as used in RISC processors. Secondly, this instruction encoding technique permits branches to go only to instructions beginning with the first of the three operations without incurring significant implementation difficulty, and “wastes” bits for specifying the interaction between instructions (i.e., instruction stop bits). Thirdly, this three operation bundle format not only forces additional complexity in the implementation in order to deal with three operations at once, but it has no requirement to be compatible with existing fixed width instruction encodings, such as the conventional 32-bit RISC encodings.

FIG. 8 is an exemplary decoding process for VLIW instruction bundles containing several operations with fixed opcode width. In particular, FIG. 8 is a flow diagram of a known process for decoding the fixed width bundles in FIG. 7. In this exemplary process, a VLIW processor first selects instruction bytes for decoding (step 802). The VLIW processor decodes the first slot operation of the instruction bundle (step 804). The VLIW processor then decodes the second slot operation of the instruction bundle (step 806) and the third slot operation of the instruction bundle (step 808). Once the instruction bundle has been decoded, the VLIW processor shifts the instruction buffer by 128 bits (step 810), thereby eliminating the decoded bundle and allowing the processor to view the next bundle.

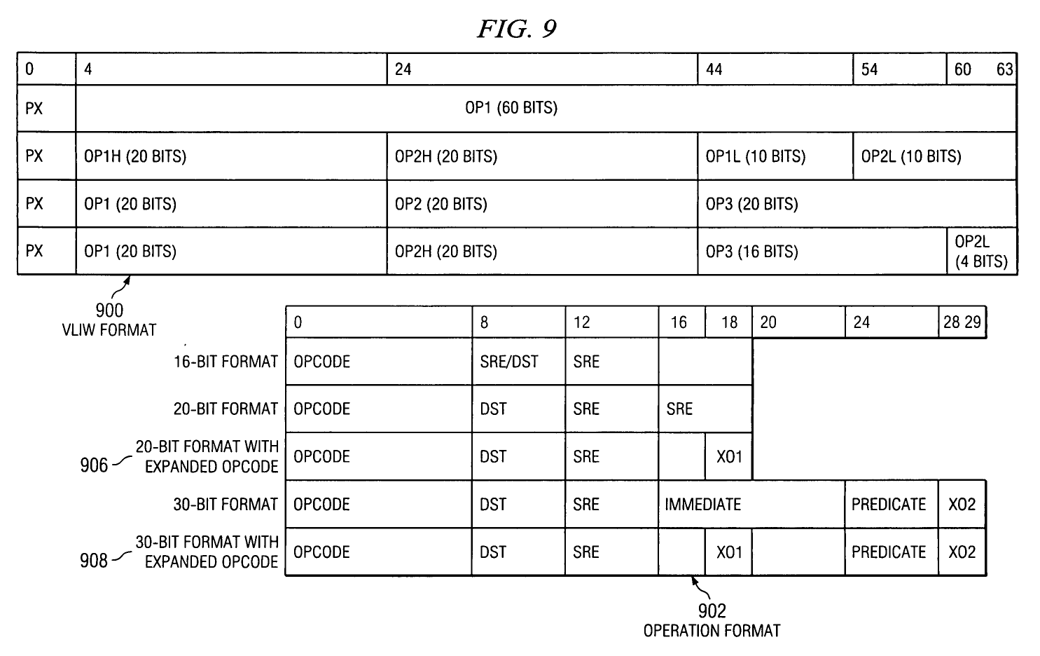

FIG. 9 is an exemplary diagram of a known advanced LIW (long instruction word) or VLIW (very long instruction word) architecture supporting 64-bit instruction words having between 1 to 3 operations of variable length. This advanced VLIW architecture is described in J. Moreno et al., “An Innovative Low-Power High Performance Programmable Signal Processor For Digital Communications”, IBM J. RES. & DEV., VOL. 47, NO. 2/3, MARCH/MAY 2003, and incorporated herein by reference. In particular, as shown in FIG. 9, advanced VLIW instruction format 900 comprises of a sequence of long instruction words, each containing a four-bit prefix (PX) or format specifier, and one, two, or three instructions. The prefix/format specifier comprises information that is used to identify the number of instructions that are contained in the instruction bundle and the length of each instruction. A long instruction is the minimum unit of program addressing possible, represented in memory as a 64-bit entity. All operations within such an instruction, regardless of their length, contain a fixed-size opcode in bits 0:7 specifying the operation to be performed, as shown in VLIW operation format 902. Some instructions, such as operation 904, specify an expanded opcode field in bits 18:19 (XO1). Operations of 30-bit length, such as operation 906, specify additional opcode information in bits 28:29 (XO2).

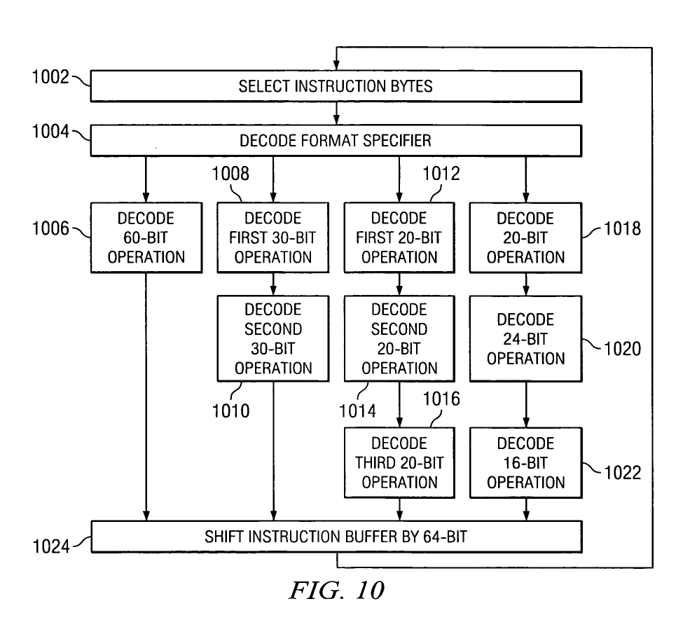

FIG. 10 is an exemplary decoding process in a VLIW architecture for 64-bit instruction words between 1 to 3 operations of variable length, such as specified for the eLite DSP architecture. In particular, FIG. 10 is a flow diagram of a known process for decoding the advanced VLIW bundle format in FIG. 9. In this exemplary process, the processor first selects instruction bytes for decoding (step 1002). The processor decodes the format specifier for the instruction bundle (step 1004). If the information in the format specifier field indicates that the instruction bundle contains one operation, the processor decodes the 60-bit operation (step 1006). Once the operation has been decoded, the processor shifts the instruction buffer by 64 bits (step 1024), thereby eliminating the decoded instruction bundle and allowing the processor to view the next instruction bundle. The process returns to step 1002 if additional instruction words are to be decoded.

Turning back to step 1004, if the information in the format specifier field indicates that the instruction bundle contains two operations of 30 bits each, the processor decodes the first 30-bit operation of the instruction bundle (step 1008), and then decodes the second 30-bit operation (step 1010). The processor then shifts the instruction buffer by 64 bits (step 1024), and the process returns to step 1002 if additional instruction words are to be decoded.

The information in the format specifier field may also indicate that the format specifier contains three operations. If the format specifier discloses that the three operations are of equal length, the processor decodes the first 20-bit operation of the instruction bundle (step 1012), decodes the second 20-bit operation (step 1014), and then decodes the third 20-bit operation (step 1016). The processor then shifts the instruction buffer by 64 bits (step 1024), and the process returns to step 1002 if additional instruction words are to be decoded.

If the format specifier discloses that the three operations are of varying length, the processor decodes the each operation. For example, the processor may decode the first operation in the instruction bundle (e.g., 20-bits) (step 1018), decode the second operation (e.g., 24-bit) (step 1020), and then decode the third operation (e.g., 16-bit) (step 1022). The processor then shifts the instruction buffer by 64 bits (step 1024), and the process returns to step 1002 if additional instruction words are to be decoded.

As other LIW or VLIW instruction formats, this format is designed to encode multiple operations to be executed in parallel, and not independent instructions to be issued dynamically by the instruction issue logic of a RISC processor. Furthermore, the specific encoding format is to be used for all instruction words executed by an LIW or VLIW processor, and thus cannot be included compatibly in a fixed width RISC ISA.

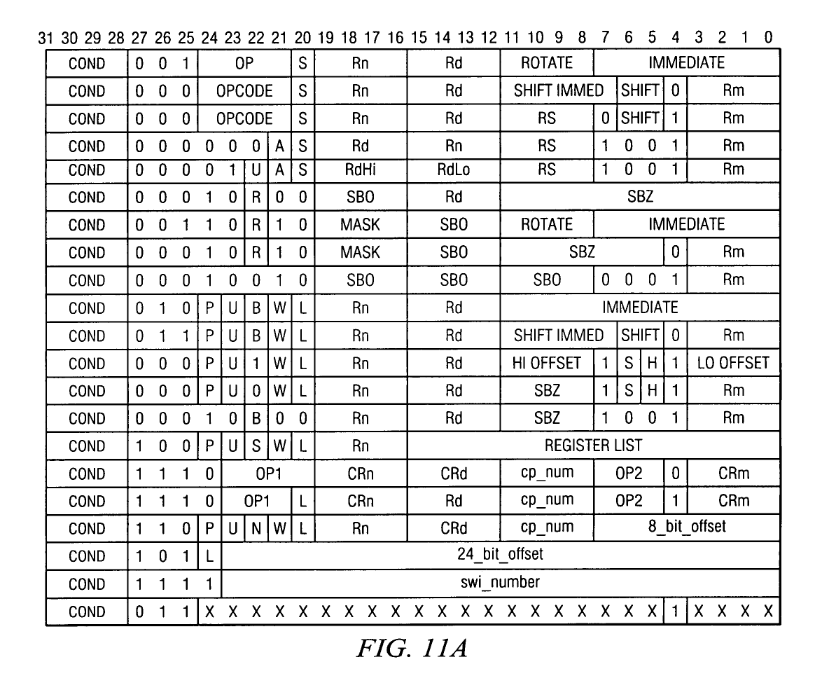

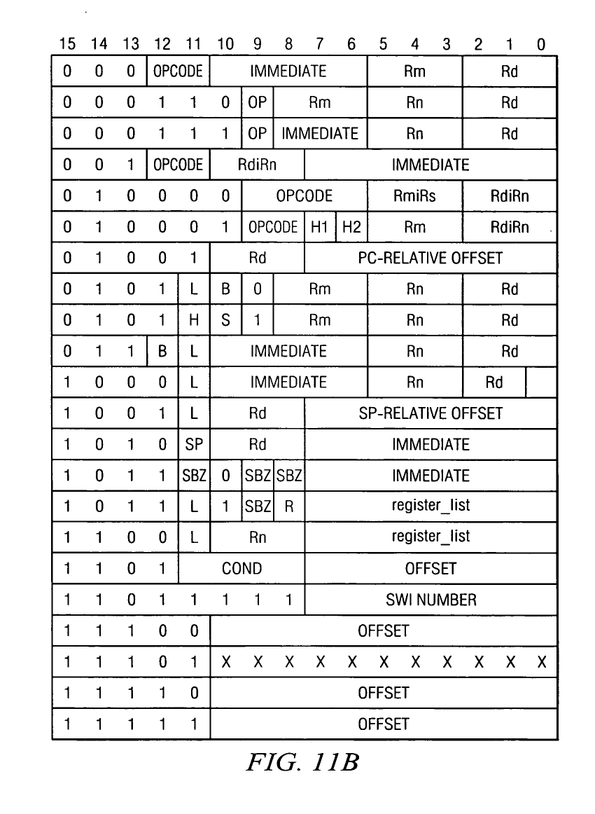

FIGS. 11A and 11B illustrate instruction sets for a “dual instruction set” microprocessor, based on known ARM and Thumb microprocessor instruction formats.

An exemplary diagram of an ARM instruction set format is shown in FIG. 11A. The figure shows instructions to consist of an operation code starting at bit 27 and generally 8 bits wide, part of which is used to specify one of the listed 32-bit instruction formats shown. Each instruction contains a conditional execution predicate in bits 31-28. Since typically, few instructions are to be conditionally executed the conditional instruction field is a source of encoding inefficiency. Furthermore, in predicted code, several instructions usually are predicated by the same predicate and predicate condition, leading to further encoding inefficiency by duplication predicate information when such information is needed. All ARM instructions are 32-bit wide fixed width RISC instructions.

FIG. 11B is an exemplary diagram of a known format of a Thumb instruction set. All Thumb instructions are 16 b wide fixed width RISC instructions. To accommodate the shorter instruction format, the number of bits available for specifying register operands has been reduced to 3 bits, thus only allowing Thumb code to typically reference up to 8 registers of the full 32 registers available in an ARM processor. Furthermore, the Thumb instruction set does not have a conditional execution field in all instruction formats.

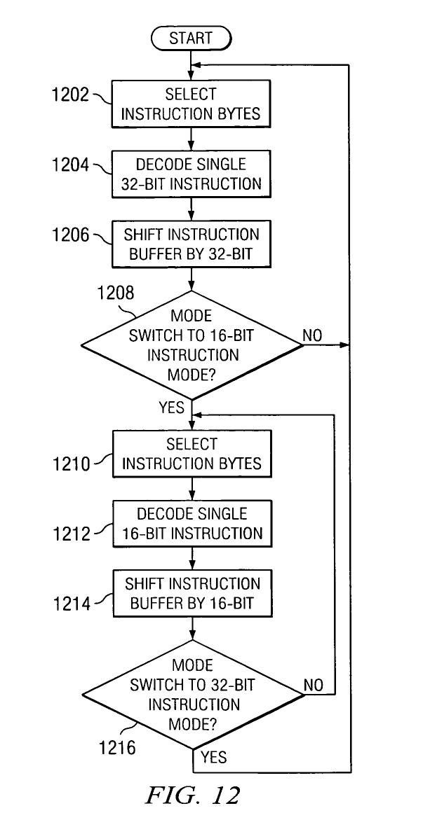

FIG. 12 is an exemplary decoding process for instructions in a dual-format ISA microprocessor. In particular, FIG. 12 is a flow diagram of a known process for decoding the ARM and Thumb microprocessor instruction formats in FIGS. 11A and 11B. In this exemplary process, the dual-format microprocessor first selects instruction bytes for decoding (step 1202). In this example, the selected instruction bytes comprise a single 32-bit instruction. The microprocessor decodes the single 32-bit instruction (step 1204), and then shifts the instruction buffer by 32 bits (step 1206) to allow the microprocessor to view the next instruction.

Next, the microprocessor determines if there is a mode switch to another instruction mode (step 1208), such as, for example, to a 16-bit instruction mode. Switching to another instruction format mode occurs with an instruction mode switching instruction, i.e., an instruction specifying a switch between instruction modes. If not, the process returns to step 1202, and the microprocessor selects another 32-bit instruction to decode.

If a switch is detected in step 1208, the microprocessor selects the next single 16-bit instruction bytes for decoding (step 1210). The microprocessor decodes the single 16-bit instruction (step 1212), and then shifts the instruction buffer by 16 bits (step 1214) to allow the microprocessor to view the next instruction.

Next, the microprocessor determines if there is a mode switch to the 32-bit instruction mode (step 1216). If not, the process returns to step 1210, and the microprocessor selects another 16-bit instruction to decode. If a switch is detected in step 1216, the microprocessor returns to step 1202 and selects the next 32-bit instruction bytes for decoding.

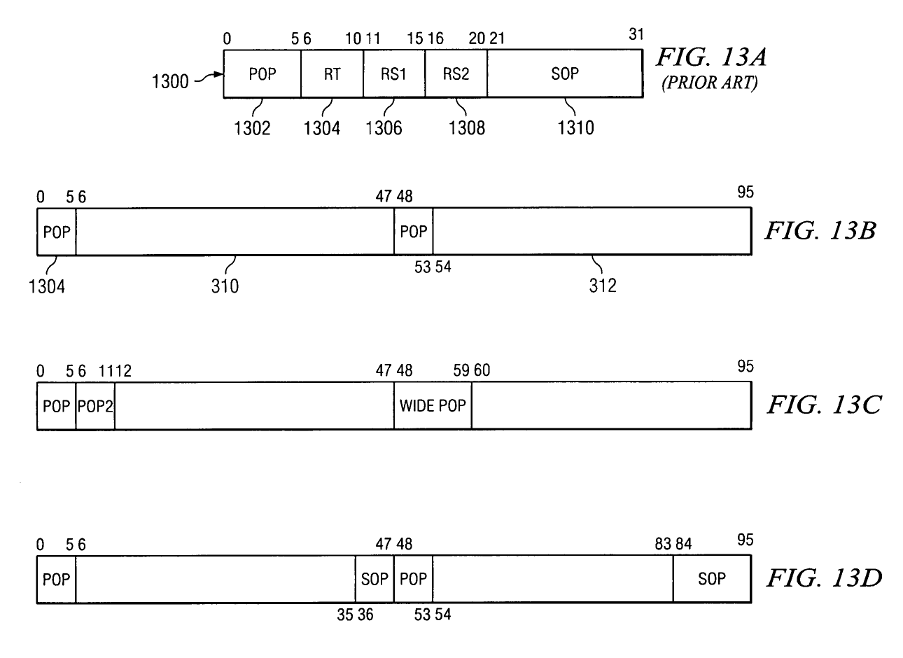

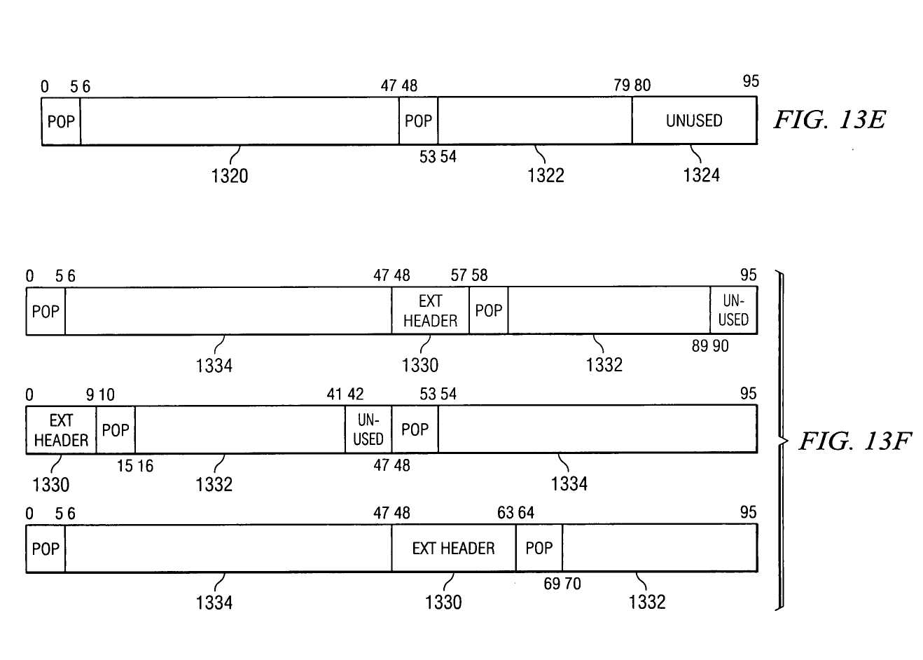

Turning now to FIG. 13A, an exemplary diagram of a known 32-bit PowerPC™ instruction is shown. In the PowerPC™ instruction set architecture, all instructions have a fixed with of 32 bits. A detailed overview of the PowerPC architecture is provided in “The PowerPC Architecture—A Specification for a New Family of RISC Processors”, C. May, E. Silha, R. Simpson, H. Warren (eds.), Morgan Kaufmann Publishers, San Francisco, Calif., 1994.

According to the PowerPC instruction encoding scheme, PowerPC instruction 1300 includes a first primary opcode (POP) 1302. Primary opcode 1302 comprises 6 bits, numbered bits 0 to 5. The primary opcode establishes the broad encoding format for the remaining instruction bits. Several instruction formats exist, with the format shown in FIG. 13A using the frequent 3-operand register to register compute operation encoding for further exposition. The primary opcode identifies this format, and implies the presence of one or more bits of secondary opcode (SOP) 1310 in bits numbered 21 to 31. Furthermore, the instruction has three 5-bit fields, indicating the target register (RT) 1304 in bits numbered 6 to 10, a first source register (RS1) 1306 in bits numbered 11 to 15, and a second source register (RS2) 1308 in bits numbered 16 to 20.

In contrast, FIGS. 13B-13D depict exemplary implementations of PowerPC™ instruction encoding groups in accordance with preferred embodiments of the present invention. Specifically, FIG. 13B is an exemplary diagram illustrating a 48-bit PowerPC™ instruction paired with another 48-bit instruction to yield a 96-bit encoding group in accordance with a preferred embodiment of the present invention. In this illustrative embodiment, extended width instructions 1310 and 1312 are incorporated in an encoding group and encoded into two extended instruction words of 48 bits each, wherein the extended width instructions correspond to three fixed width instructions. According to this embodiment, first instruction 1310 of the extended width instruction type includes primary opcode 1314 consistent with the underlying fixed width instruction coding. Thus, in an exemplary embodiment extending PowerPC™, primary opcode 1314 indicates a fixed width instruction comprising 6 bits and indicates that the instruction is of extended width type. In one embodiment, only a single primary opcode may be allocated to indicate a wide instruction beginning an encoding group, and the specific type is encoded in additional instruction bits of the 48-bit extended width instruction, e.g., such as including but not limited to an extended primary opcode starting at bit 6 as shown in FIG. 13C, or an extended secondary opcode field as shown in FIG. 13D. In another embodiment, several primary opcodes may be allocated to extended width instruction formats, optionally indicating specific subclasses of instructions, instruction types, or instruction formats used by extended width instructions.

In addition, another feature of the present invention shown in FIG. 13B depicts the mandatory pairing of two extended width instructions to form a 96-bit instruction encoding group. The instruction encoding group is an integral multiple of the original fixed width instruction size.

FIG. 13C is an exemplary embodiment illustrating an encoding group consisting of two paired 48-bit instructions; the encoding group being indicated by the opcode of a first 48-bit instruction, the instruction having a 12-bit primary opcode consisting of a first 6-bit opcode portion and a second 6-bit opcode portion. According to this exemplary embodiment, a first 6-bit segment of the 12-bit opcode of 48-bit instructions (labeled POP), in a first instruction indicating the beginning of an encoding group has been allocated as at least one available opcode in the base instruction set architecture. A second segment of the 12-bit opcode (labeled POP2) of a first instruction indicating the start of an encoding group provide the ability to encode additional operations. A second instruction in an encoding group does not have to indicate the beginning of an encoding group. As such, it may either consist of a segmented opcode as said first instruction, or a single wide opcode (labeled wide POP) of which all 12 bits can be allocated to new operations.

FIG. 13D is an exemplary diagram illustrating an encoding group consisting of two paired 48-bit instructions, the encoding group being indicated by the 6-bit opcode of a first 48-bit instruction, with 48-bit extensions also having a 12-bit secondary opcode. A first instruction consists indicating the beginning of an encoding group has been allocated as at least one available opcode in the base instruction set architecture. A second 48-bit instruction in an encoding group does not have to indicate the beginning of an encoding group. As such, it may use the at least one allocated primary opcode in accordance with the first instruction, or a primary opcode for which all bits can be allocated to new operations.

FIG. 13E is an exemplary diagram illustrating a 48-bit PowerPC™ instruction paired with a 32-bit instruction and a 16-bit unused field in accordance with a preferred embodiment of the present invention. FIG. 13E illustrates another embodiment of the present invention, in which an extended width instruction, such as extended width instruction 1320, is paired with a base fixed width instruction, such as base fixed width instruction 1322. First instruction 1320 of extended width type is used to initiate an encoding group. Successive fixed width instructions, such as instruction 1322, may be padded with bit fields, such as unused bit field 1324. The fixed width instructions are padded in order to align 32-bit instructions within the extended instruction encoding group. In this manner, extended width instructions are allowed to integrate with fixed width instructions without permanently changing the alignment of all following instructions, and thereby the problems associated with variable width instruction words are avoided. An exemplary implementation of padding after the second instruction word is shown in FIG. 13E, but other implementations can provide padding before an instruction word, before and after an instruction word, or even within an instruction word. Furthermore, padding can be represent “unused” bits in an instruction stream, or modify and extend the meaning of specific instructions, or subfields thereof. In one exemplary use of a padding field, the bits represent additional bits to be used in the addressing of register operands in the register field, to allow usage of more registers than would be possible with the encoding formats of the base architecture fixed width RISC instruction words.

FIG. 13F also depicts another embodiment of the present invention. In particular, FIG. 13F illustrates exemplary diagrams of a 48-bit PowerPC™ instruction paired with a 32-bit instruction having a special header to identify using a 32-bit instruction in a 48-bit encoding slot in accordance with a preferred embodiment of the present invention. In these illustrative examples, pairing of at least one extended width instruction with a base fixed width instruction is supported. An extension header 1330 may be used to indicate that a base instruction encoding 1332 is used in an encoding group slot together with an extended width instruction 1334. In the described scenario, a PowerPC or other 32-bit fixed width RISC instruction compliant with the base instruction set and a POP allocated in the base instruction set is modified or extended with additional bits indicating the use of a base instruction in a wider issue slot. In addition, unused bits may also be present in the encoding group.

FIG. 14 is an exemplary decoding process for instructions in a RISC processor in accordance with a preferred embodiment of the present invention. Specifically, FIG. 14 provides a flow diagram of a RISC processor supporting the presence of 32-bit instructions or paired 48-bit instructions as shown in FIGS. 13B-13F in accordance with a preferred embodiment of the present invention. FIG. 14 also supports the presence of encoding groups having an integral multiple of the base instruction width.

In this exemplary process, the RISC processor first selects instruction bytes for decoding (step 1402). A determination is then made as to whether the opcode for the instruction indicates that an encoding group exists (step 1404). If not, the processor decodes the single 32-bit instruction (step 1406), and then shifts the instruction buffer by 32 bits (step 1408) to allow the processor to view the next instruction. The process then returns to step 1402.

If it is determined that the opcode indicates that an encoding group is present in step 1404, the processor decodes the first instruction in the encoding group (step 1410). The processor then decodes the second instruction in the encoding group (step 1412), and then shifts the instruction buffer by 96 bits (step 1414) to allow the microprocessor to view the next instruction words in the instruction stream. The process then returns to step 1402.

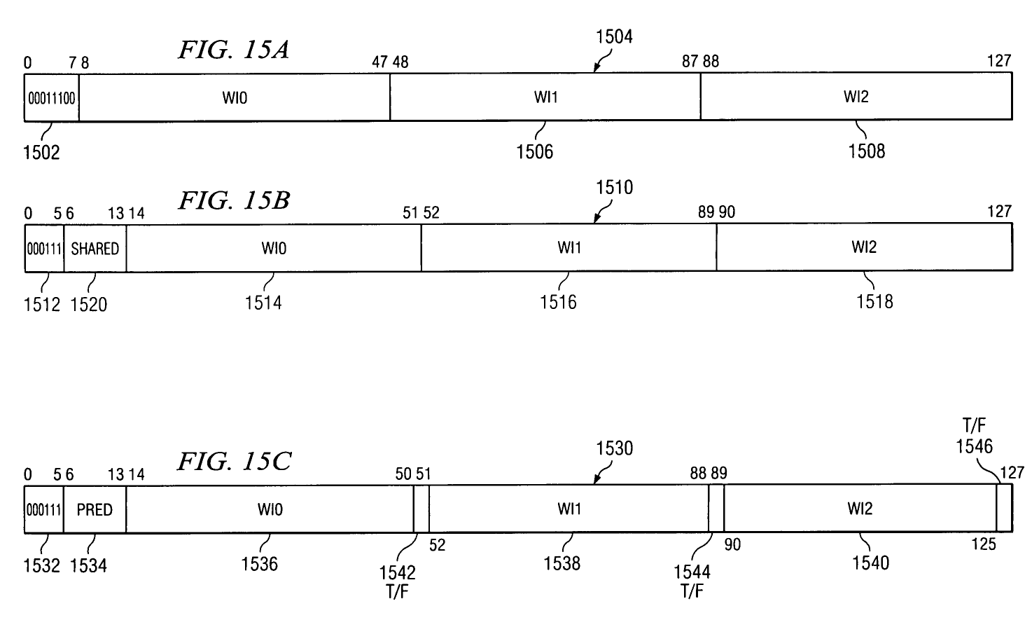

While previous ISAs have supported bundles, they have not supported the concept of encoding groups which represent instructions which can be executed sequentially, or in parallel, in accordance with data dependences established by the instruction scheduler of a processor. Thus, instruction extensions such as the FLIX instructions require supporting the start of instructions at arbitrary byte addresses. Furthermore, FLIX bundles represent VLIW instructions encoding multiple operations to be executed in parallel, restricting the freedom of the instruction scheduler, as well as of microarchitects in choosing what resources to share. On the other hand, instruction encoding groups do not imply the presence or absence of parallelism, as is the case in previous encoding formats such as operation bundles. Instead, they allow the efficient encoding of fixed width and extended width instructions in a fixed width ISA coding system. FIGS. 15A-15C illustrate additional embodiments of instruction encoding groups that may be used in accordance with the present invention.

FIG. 15A is an exemplary diagram depicting instruction encoding group for the PowerPC™ architecture in accordance with a preferred embodiment of the present invention. In this illustrative example, three 40-bit instructions are encoded. This encoding uses one PowerPC™ primary opcode, e.g., primary opcode 1502. Primary opcode 1502 comprises 6 bits, and specifies the start of the instruction encoding group. For example, single base ISA primary opcode 1502 is used to indicate the start of three instruction encoding group 1504 containing three 40-bit instructions. Instruction group 1504 is four times the width of the base 32-bit fixed width instruction.

The 6-bit base ISA opcode 1502 is allocated to indicate the presence of an encoding group. In FIG. 15, this exemplary opcode “000111” has been extended with 2 bits having the value “00” to ensure an encoding group, having three 40-bit instructions and a header consisting of 6 opcode bits indicating the start of an instruction encoding group and 2 padding bits, will match the chosen 128-bit instruction encoding group.

With the present invention, a set of extended width instructions may be allocated at an appropriate fixed width instruction boundary, and ending at such boundary. Thus, while longer instruction words may be added, the overall architecture, and specifically aspects such as the branch architecture, continues to operate on word boundaries. In one embodiment using instruction encoding groups, branch targets must branch to the beginning of an encoding group having an extended with instruction. In another embodiment, the unused two lower bits of instruction addresses (indicating byte addresses which are not a multiple of 4, and which are currently unused) are used to indicate a branch target of a second instruction (wi1) 1506 or a third instruction (wi2) 1508, rather than a specific address.

FIG. 15B is an exemplary diagram illustrating an encoding group having shared fields in accordance with a preferred embodiment the present invention. The encoding group shown in FIG. 15B may be used to encode shared information across several instructions. Encoding group 1510 comprises primary opcode 1512 which indicates the presence of an encoding group. In this illustrative example, primary opcode 1512 indicates that encoding group 1510 includes three instructions 1514, 1516, and 1518, each instruction having 38 bits, and shared field 1520 having 8 bits. Shared field 1520 may be used to encode an instruction or indicate the selection of a specific rounding mode for all floating point instructions encoded in such instruction encoding group. In another embodiment, shared field 1520 may be an address space identifier to be used by all memory access instructions encoded in the group.

In one implementation of group instruction encodings, shared field 1520 may comprise a facility selector and facility bits. Thus, one encoding group may contain a selector indicating the shared resource modifies the floating point rounding mode, and the facility bits would indicate the rounding mode. Another encoding group in the same program may have a facility selector indicating the shared resource modifies the address space selection for memory access instructions, and the facility bits would specify the specific address space, and so forth. In this manner, the shared resource can be used to select from a variety of shared facilities, based on the programmer's wishes on how to modify the specific instructions in a specific instruction encoding group.

FIG. 15C is an exemplary diagram illustrating an encoding group having a shared predicate field and a one-bit true/false indicator in accordance with a preferred embodiment of the present invention. In particular, the group encoding in FIG. 15C shows how shared fields may be used to support predication in encoding groups. In this exemplary embodiment supporting shared predicates for instructions within a group, encoding group 1530 comprises 6-bit primary opcode 1532 which is used indicate the presence of an encoding group, and shared predicate specifier 1534. Encoding group 1530 also comprises three 38-bit instructions 536-540, each instruction having an additional predicate field 542-546 indicating whether to nullify the specific instruction when the global predicate is either true (T) or false (F). For example, an instruction word may be nullified if the true/false indicator indicates that a global predicate in the shared predicate field is false. In another embodiment, the encoding group includes a shared condition register field, and at least one condition field associated with at least one instruction. Thus, this encoding embodiment may be used to efficiently encode conditional program control flow and share a global predicate for increased code density, while achieving flexibility by augmenting the globally encoded shared instruction information with instruction-specific information. This allows a highly efficient implementation of predicated (or “guarded”) execution, e.g., by encoding the predication (or “guarding”) facility described by “Guarded Execution and Branch Prediction in Dynamic ILP Processors”, D. Pnevmatikatos and G. S. Sohi, 21th International Symposium on Computer Architecture, 1994, as part of the encoding group.

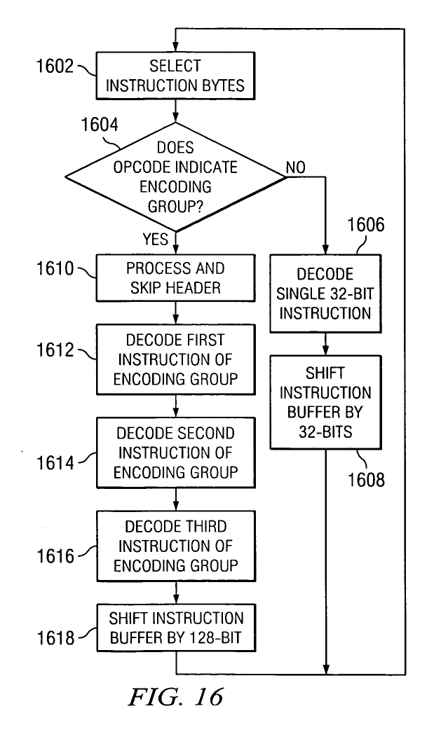

FIG. 16 is a flow diagram of a process for decoding instructions in a RISC processor having 32-bit fixed width instructions in FIG. 13A and encoding groups of three instructions having a total of 128-bits in FIG. 15A or 15B in accordance with a preferred embodiment of the present invention. As the new encoding technique of the present invention allows for combining extended instruction words with fixed length instruction words designed to provide the ability to add new instructions and opcode encodings to many different architectures, the process in FIG. 16 provides an example of how extended instruction words and fixed length instruction words used in conjunction may be decoded.

The process begins with having the RISC processor select the instruction bytes to decode (step 1602). The process then determines if the opcode in the instruction indicates that the selected instructions bytes are part of an encoded group (step 1604). If not, the RSIC processor decodes the single 32-bit instruction (step 1606), and shifts the instruction buffer by 32-bits (step 1608), with the process returning to step 1602.

Turning back to step 1604, if the opcode in the instruction indicates that the selected instruction bytes are part of an encoding group, the RISC processor processes and skips the encoded header (step 1610). Next, the RISC processor decodes the first instruction in the encoding group (step 1612). The RISC process decodes the second instruction of the encoding group (step 1614), and then decodes the third instruction in the encoded group (step 1616). Once each instruction in the encoding group is decoded, the RISC processor shifts the instruction buffer by 128-bits (step 1618), with the process returning to step 1602.

Although the example process in FIG. 16 illustrates basic steps for decoding an encoded group of instruction words, it should be noted that other decoding steps may also be used to implement the present invention. In addition, the decoding steps may be executed sequentially or in parallel. A process may also be split into several phases, such as, for example, a predecode phase, a first decode phase, a second decode phase, etc.

FIGS. 13B-13D and 15A-15C describe encoding group formats where all encoded instructions have the same width and format. While this is desirable in one aspect of implementation and code generation to ensure orthogonal code in the structure, in another aspect of code generation and specifically code density, it may be desirable to support asymmetric instruction encoding groups. In one embodiment of an asymmetric encoding group, not all instructions are of the same width. In another embodiment, not all instructions have the same internal format, or fields, or field widths. In one embodiment, only one type of asymmetric instruction encoding group is supported. In another embodiment, multiple asymmetric instruction encoding groups are supported. When multiple asymmetric instruction encoding groups are supported, the type of asymmetric encoding instruction group is preferably indicated by the opcode, an encoding group header, or a mode bit in the processor state, or other appropriate selection mechanism.

While the aspects of this present invention have been presented in the context of fixed width RISC instruction set architectures, some aspects of instruction encoding groups may be advantageously practiced in conjunction with other ISAs. In one such use, instruction encoding groups may be used to specify shared fields. In one such advantageous use of instruction encoding groups for other instruction set architectures, a predicate field may be shared between several instructions.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, and as was noted above, this invention is not limited to the use of any specific instruction widths, instruction extension widths, code page memory sizes, specific sizes of partitions or allocations of code page memory and the like, nor is this invention limited for use with any one specific type of hardware architecture or programming model, nor is this invention limited to a particular instruction pipeline. The use of other and similar or equivalent embodiments may be attempted by those skilled in the art. However, all such and similar modifications of the teachings of this invention will still fall within the scope of this invention.

Further, some of the features of the present invention could be used to advantage without the corresponding use of other features. As such, the foregoing description should be considered as merely illustrative of the principles of the present invention, and not in limitation thereof.

What is claimed is:

1. A method in a data processing system for processing fixed width instruction words in conjunction with extended width instruction words in an instruction stream, comprising:
processing fixed width instruction words in the instruction stream in accordance with a fixed width instruction set architecture; and
processing extended width instruction words in the instruction stream;
wherein instructions in the instruction stream are generated by encoding steps comprising:
inserting a plurality of instruction words into the fixed width instruction set architecture to form an encoding group of instruction words, wherein the plurality of instruction words includes one or more extended width instruction words; and
creating one or more indicators for the encoding group, wherein one indicator is used to indicate the presence of the encoding group.

2. The method of claim 1, further comprising:
selecting instruction bytes for decoding;
reading the indicators to determine if the selected instruction bytes comprise an encoding group of instruction words;
responsive to a determination that the selected instruction bytes comprise an encoding group, decoding each instruction word in the encoding group; and
shifting the instruction buffer by the size of the encoding group.

3. The method of claim 2, wherein the decoding of each instruction word in the encoding group is performed one of sequentially or in parallel.

4. The method of claim 1, wherein the encoding group includes at least one extended width instruction and at least one fixed width instruction word.

5. The method of claim 4, wherein a field is added to the fixed width instruction word to align the fixed width instruction word within the encoding group.

6. The method of claim 5, wherein the field contains bits used in addressing register operands in a register field.

7. The method of claim 1, wherein additional indicators are used in the encoding group to indicate one of a specific subclass of instructions, instruction types, and instruction formats used by extended width instructions.

8. The method of claim 1, wherein an extension to the one or more indicators is used to indicate that an encoding fixed width instruction word is paired with an extended width instruction word.

9. The method of claim 1, wherein the encoding group includes a shared field, wherein the shared field contains shared information across the plurality of instruction words.

10. The method of claim 9, wherein the shared field indicates selection of a specific rounding mode for all floating point instructions encoded in the encoding group.

11. The method of claim 10, wherein the shared field is an address space identifier used by all memory access instructions encoded in the encoding group.

12. The method of claim 1, where the encoding group includes one of a shared predicate field and condition register field and one of a true/false and condition indicator.

13. The method of claim 9, wherein the shared field contains a facility selector that allows for selecting between multiple shared fields.

14. The method of claim 1, where the one indicator is the primary opcode of the first instruction of the encoding group.

15. The method of claim 1, where the one indicator is an encoding group header of the encoding group.

16. A system for processing instruction streams containing fixed width instruction words and encoding groups, comprising:
an instruction decode unit for decoding instruction words of a first fixed width and encoding groups having instruction words of a second fixed width and at least one extended width instruction word, wherein the instruction decode unit decodes a set of bits in an instruction, and wherein the set of bits indicate the presence of one of a fixed width instruction word or an encoding group; and
dispatching and executing units for dispatching and executing instruction words in the encoding group, wherein the dispatching and executing steps are performed one of independently or in parallel based on a specific microprocessor implementation, and wherein the encoding group does not indicate any form of required parallelism or sequentiality.

17. The system of claim 16, wherein additional indicators are used in the encoding group to indicate one of a specific subclass of instructions, instruction types, and instruction formats used by extended width instructions.

18. The system of claim 16, wherein the encoding group includes a shared field, wherein the shared field contains shared information across the plurality of instruction words.

19. A computer program product in a computer readable medium for processing fixed width instruction words in conjunction with extended width instruction words in an instruction stream, comprising:
first instructions for processing fixed width instruction words in the instruction stream in accordance with a fixed width instruction set architecture; and
second instructions for processing extended width instruction words in the instruction stream;
wherein instructions in the instruction stream are generated by encoding steps comprising:
first sub-instructions for inserting a plurality of instruction words into the fixed width instruction set architecture to form an encoding group of instruction words, wherein the plurality of instruction words includes one or more extended width instruction words; and
second sub-instructions for creating one or more indicators for the encoding group, wherein one indicator is used to indicate the presence of the encoding group.

20. The computer program product of claim 19, further comprising:
third instructions for selecting instruction bytes for decoding;
fourth instructions for reading the indicators to determine if the selected instruction bytes comprise an encoding group of instruction words;
fifth instructions for decoding each instruction word in the encoding group in response to a determination that the selected instruction bytes comprise an encoding group; and
sixth instructions for shifting the instruction buffer by the size of the encoding group.
